(19) United States
(12) Patent Application Publication
(10) Pub. No.: US 2010/0309327 A1
(43) Pub. Date: Dec. 9, 2010

(54) CAMERA

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/504,664

(22) Filed: Jul. 17, 2009

(30) Foreign Application Priority Data
Jun. 5, 2009 (CN) 200910302975.9

(51) Int. Cl. H04N 5/225

(52) U.S. Cl. 348/222.1; 348/E05.024

(57) ABSTRACT

A camera includes an image capture unit, a storage unit, a selection unit, and a processing unit. The image capture unit captures images. The storage unit stores a number of detection modules. The selection unit selects one or more detection modules. The processing unit executes one or more detection modules according to the selection unit, to detect specified features within the images captured by the image capture unit.

### BACKGROUND

1. Technical Field

The present disclosure relates to a camera.

2. Description of Related Art

Cameras usually cannot discern specific features, such as faces, in images. To detect such features in the images, the images must be transferred to a computer system for software-based processing, which is inconvenient.

### BRIEF DESCRIPTION OF THE DRAWINGS

FIG. 1 is a schematic block diagram of an exemplary embodiment of a camera including a storage unit and a selection unit.

FIG. 2 is a schematic block diagram of the storage unit of FIG. 1.

FIG. 3 is a schematic block diagram of an exemplary embodiment of the selection unit of FIG. 1.

FIG. 4 is a schematic block diagram of another exemplary embodiment of the selection unit of FIG. 1.

### DETAILED DESCRIPTION

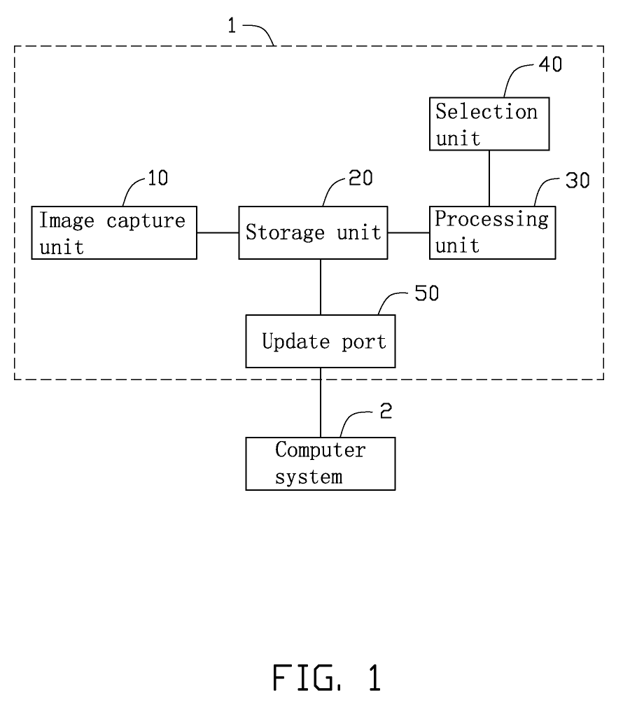

Referring to FIG. 1, an exemplary embodiment of a camera 1 includes an image capture unit 10, a storage unit 20, a processing unit 30, a selection unit 40, and an update port 50.

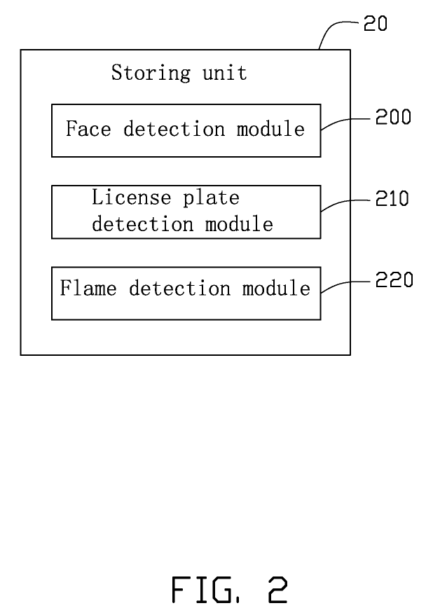

Referring to FIG. 2, the storage unit 20 stores a face detection module 200, a license plate detection module 210, and a flame detection module 220.

The image capture unit 10 is operable to capture images of objects. The selection unit 40 is operable to select the face detection module 200, the license plate detection module 210, or the flame detection module 220 via the processing unit 30. It can be understood that the processing unit 30 executes the face detection module 200, which, in turn, seeks the designated features, in this case, faces, within images from the image capture unit 10. The processing unit 30 executes the license plate detection module 210, which, in turn, seeks the designated features, in this case, license plates within images from the image capture unit 10. The processing unit 30 executes the flame detection module 200, which, in turn, seeks the designated features, in this case, flames, within images from the image capture unit 10. A known recognition technology can be employed by the face detection module 200, the license plate detection module 210, and the flame detection module 220 to locate and acquire the designated images.

The selection unit 40 transmits a signal according to the selection thereof to the processing unit 30. The processing unit 30 is operable to execute face detection module 200, license plate detection module 210, or flame detection module 220 accordingly.

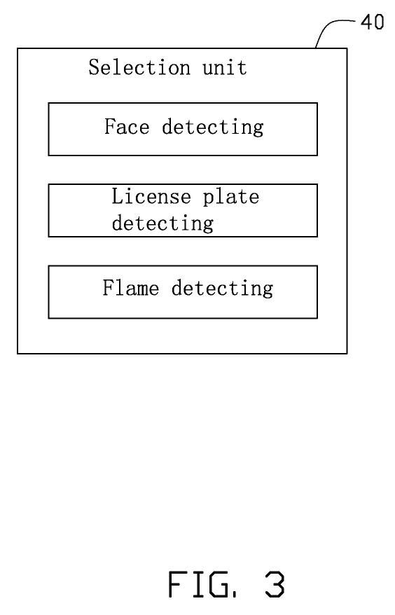

Referring to FIG. 3, it can be understood that the selection unit 40 can be an user interface providing a plurality of keys, such as a “face detecting” key, a “license plate detecting” key, and a “flame detecting” key. When the “face detecting” key is selected, the selection unit 40 transmits a first signal to the processing unit 30, and the processing unit 30 executes the face detection module 200. When the “license plate detecting” key is selected, the selection unit 40 transmits a second signal to the processing unit 30, and the processing unit 30 executes the license plate detection module 210. When the “flame detecting” key is selected, the selection unit 40 transmits a third signal to the processing unit 30, and the processing unit 30 executes the flame detection module 220.

While designated features to be detected here include, as examples, faces, license plates, and flames, storage unit 20 can equally store other detection modules, such as a movement detection module, or any other, while remaining well within the scope of the disclosure.

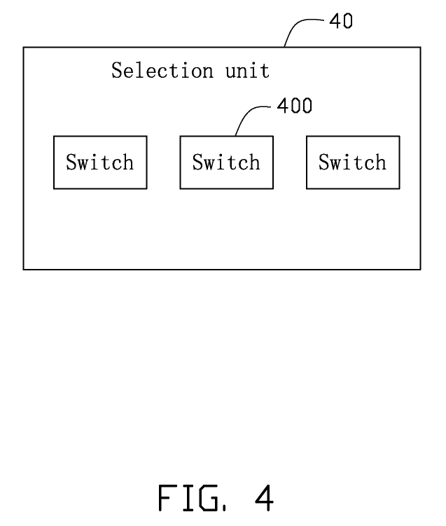

Referring to FIG. 4, the selection unit 40 may include a plurality of switches 400. Each combination status of the plurality of switches 400 corresponds to one of the first, second, and third signals. For example, when a first switch is turned on, and a second switch is turned on, a first combination status of the switches 400 is “11”. The first combination status corresponds to the first signal. The processing unit 30 implements the face detection module 200 according to the first signal. When the first switch is turned off, and the second switch is turned off, a second combination status of the switches 400 is “00”. The second combination status corresponds to the second signal. The processing unit 30 implements the license plate detection module 210 according to the second signal.

The update port 50 is operable to connect to a computer system 2. As a result, other detection modules can be downloaded to the storage unit 20 to add functions of the camera 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera comprising:
an image capture unit;
a storage unit, storing a plurality of detection modules;
a selection unit to select one of the plurality of detection modules; and
a processing unit to execute the selected detection module to detect features in images captured by the image capture unit as designated by the detection module.

2. The camera of claim 1, wherein the plurality of detection modules comprises a face detection module.

3. The camera of claim 1, wherein the plurality of detection modules comprises a license plate detection module.

4. The camera of claim 1, wherein the plurality of detection modules comprises a flame detection module.

5. The camera of claim 1, wherein the selection unit comprises a plurality of keys, each corresponding to one of the plurality of detection modules.

6. The camera of claim 1, wherein the selection unit comprises a plurality of switches, combined statuses of which correspond to one of the plurality of detection modules.

7. The camera of claim 1, further comprising an update port, wherein the update port is to connect to a computer system to download detection modules to the storage unit.
